(19) United States
(12) Patent Application Publication
(10) Pub. No.: US 2008/0201540 A1
(43) Pub. Date: Aug. 21, 2008

(54) PRESERVATION OF INTEGRITY OF DATA ACROSS A STORAGE HIERARCHY

(76) Inventors: Ravi Sahita, Beaverton, OR (US); Uday R. Savagaonkar, Beaverton, OR (US); David Durham, Beaverton, OR (US)

Correspondence Address: INTEL/BLAKELY, 1279 OAKMEAD PARKWAY, SUNNYVALE, CA, 94085-4040, US

(21) Appl. No.: 11/676,031

(22) Filed: Feb. 16, 2007

(51) Int. Cl. G06F 12/12

(52) U.S. Cl. 711/159

(57) ABSTRACT

A method and apparatus for preservation of integrity of data across a storage hierarchy. An embodiment of a method includes verifying integrity of a memory page that is stored in primary computer memory. The memory page is swapped out of the primary computer memory to a secondary memory, wherein swapping the memory page out includes performing an integrity check of the memory page. The memory page is swapped in the primary computer memory from the secondary memory, wherein swapping in the memory page includes verifying the integrity of the memory page based at least in part on the integrity check performed for swapping out the memory page.

### FIELD

Embodiments of the invention relate to security of computer memory. More particularly, embodiments of the invention relate to preservation of integrity of data across a storage hierarchy.

### BACKGROUND

In computer processes, security of memory operation remains a crucial issue. Malware unfortunately continues to increase in sophistication as computer security is improved. In one example, modern viruses and worms are capable of breaching the user/kernel boundary in operation. This creates a potential for system attacks and significant risk to system operations.

Certain solutions have been devised to address this type of problem to some extent. For example, the XD (eXecute Disable) bit provided in EM64T (64-bit extensions) for microprocessors indicates whether a memory area is being utilized for static data or for code, disabling execution if code installed in a data-only area attempts to run. This bit provides protection in certain circumstances.

However, the existing solutions do not protect software agents from certain possible attacks. Spyware, root-kits, and E-mail viruses are still capable of penetrating computing systems despite XD-bit protection being enabled. In particular, a computer system may be vulnerable to attack when swapping data in and out of memory. A program may have integrity information associated with its on-disk image. However, the program's in-memory contents will differ from the program's on-disk contents due to, for example, changes performed by the Operating System loader when the program is relocated in memory. Thus, when in-memory contents are swapped out to disk, the swapped out portions of the in-memory contents will also differ from the original on-disk image of the program. Therefore, verification of the integrity of data while in physical memory or when the data is on disk before load does not protect the integrity of the data when the data is swapped into or out of memory.

For example, data that is swapped from primary memory to a secondary memory location may be attacked by malware after swapping out. Upon re-swapping back in to primary memory, the tampered data may be used before it can be re-checked by the system for integrity. Conventional methods do not protect the integrity of memory contents once they are swapped out to disk. This may present a critical issue for security in approaches that try to maintain the integrity of running code and associated data in memory.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 is an illustration of memory that is vulnerable to attack the swapping of pages;

FIG. 2 is an illustration of a system to establish integrity of data swapped from primary to secondary memory;

FIG. 3 is an illustration of an embodiment of a sector integrity field for a disk memory;

FIG. 4 is an illustration of an embodiment of a remap page table entry;

FIG. 5 is an illustration of an embodiment of a process for the set up of a system to provide swapped page data integrity protection;

FIG. 6 is an illustration of an embodiment of a run-time implementation of swapped page integrity; and

FIG. 7 is an illustration of a computer system that may be utilized an embodiment of the invention.

### DETAILED DESCRIPTION

An embodiment of the invention concerns protection of integrity of data across a storage hierarchy.

As used herein:

“Physical memory” means the primary memory system of a computer. Physical memory is commonly composed of random access memory (RAM), but other types of memory may be used.

“Virtual memory” means a system to enable a computer to operate as if the computer's memory is larger than the available physical memory. Commonly the data in excess of the physical memory space is copied (swapped) to persistent memory, such as a hard drive. Virtual memory is commonly addressed by virtual address.

“Memory swapping” means a process for “swapping out” data, generally referred to as “memory pages”, from primary storage (or physical memory) to secondary storage, commonly persistent memory, such as a hard drive. “Memory swapping” also includes a process for “swapping in” such data back from secondary storage to the primary storage. Commonly the primary storage is higher speed memory.

“Virtual machine” means a computer construct that does not exist as a physical device, but is simulated by another computer by virtualizing all physical computer and storage resources.

“Virtual machine monitor” or “VMM” means a layer of system software to enable multiple virtual machines to share platform hardware. A principal role is to arbitrate accesses to the underlying physical host platform's resources in order that multiple operating systems, which are guests of the VMM, can share them. The VMM presents to each guest OS a set of virtual platform interfaces that constitute a virtual machine (VM).

“Integrity” means the validity of a set of data based on a known good reference point. In the context of page-swapping, integrity means that the content in memory that was swapped to disk is the same as the contents of memory that were swapped in from disk. In this context, the integrity of the data is protected between swap-out and swap-in events.

In an embodiment of the invention, integrity of data is preserved across a storage hierarchy. In an embodiment of the invention, a method and apparatus are provided to protect the integrity of memory contents of a software agent when the memory contents are swapped out from primary memory to secondary memory. In an embodiment of the invention, data (including code and static data) that is swapped out is integrity checked on the way from primary memory to the swap space in the secondary memory, and is integrity verified on the return from swap space to physical memory.

In an embodiment of the invention, a page file is swapped from physical memory of a computer to persistent memory, such as a disk drive. The swap may occur in the operation of virtual memory, where the amount of virtual memory may exceed the amount of actual physical memory. The integrity of the page file can be a vulnerable element in a conventional computer system because, even if the integrity of the page file has been verified in physical memory, malware (including computer viruses, worms, and other malicious software elements) that has invaded the system potentially can attack the page file after it has been swapped out of physical memory, and, upon swapping the page file back into physical memory, the malware may attempt to cause damage before the integrity of the now compromised data may be checked again. In an embodiment of the invention, data stored that is swapped into memory is protected from this attack.

In swap operations, page tables are generally maintained to map data location. In general, a page table is a data structure that is used by a virtual memory system in a computer operating system to store the mapping between virtual addresses and physical addresses of memory. In an embodiment of the invention, data bits are added in the operating system or to virtual memory monitor (VMM) managed page tables to provide for integrity of swapped pages. In addition, modifications may be made to disk controllers on the platform to provide for integrity operation. In an embodiment, pages that are swapped out from physical memory are integrity checked on the way to swap space (on disk), and integrity is verified on the way back into physical memory (from swap space on disk). In an embodiment of the invention, the system hardware may be utilized in the protection of physical memory contents belonging to a software agent when they are swapped out to persistent storage. In a particular embodiment of the invention, a process is provided to ensure integrity of data for software programs that are protected using a VT (virtualization technology) based agent integrity method.

In an embodiment of the invention, virtual addresses are mapped to physical addresses to access memory used to store in-memory data using multiple page tables. For the processor side access to memory, guest physical addresses (GPA) are translated to host physical addresses (HPA), which may be accomplished by the virtual machine monitor (VMM) or by using specialized hardware, such as another level of VMM managed page tables. In an specific embodiment relating to the VT for Directed IO (VT-d) architecture, in order to provide for the device access to memory, a DMA (direct memory access) remapping page table structure is used to map DMA Virtual Addresses (DVA) to host physical addresses, where direct memory access describes the ability of certain hardware subsystems within a computer to access system memory for reading or writing of data independently of the central processing unit. In an embodiment, the address programmed by a guest operating system (OS) on DMA devices under its control is the DMA virtual address, where a guest operating system is the operating system running on a virtual machine.

In an embodiment of the invention, DMA remapping hardware (including, but not limited, hardware available as part of Intel VT for Directed IO, or VT-d, of Intel Corporation) may be utilized to maintain the integrity of code and data pages (such as pages protected using Intel VT-x technology) as follows:

(a) In first embodiment, a system operates by detecting page swap-in and swap-out actions as DMA events.

(b) In a second embodiment, a system operates by providing extensions to disk controllers to provide integrity protection.

In an embodiment of the invention, data integrity may be provided for a hard disk sector via a function of the disk controller for the hard drive. In one embodiment, a field that may be referred to as a sector integrity field (SIF) is added after each sector on a hard disk, hard disks being generally organized in sectors. In an example, a sector of a hard drive may persistently store swapped out pages of data belonging to a protected software agent. In an embodiment of the invention, the SIF may include the following elements:
(a) A sequence number. In one example, the sequence number is a four-byte field. In an embodiment, the sequence number is increased sequentially with data writes.
(b) An integrity check value (ICV). In one example, the integrity check number is a twenty-byte field. In an embodiment, the algorithm used to calculate the ICV may be any industry standard cryptographic mechanisms such as SHA (Secure Hash Algorithm) or HMAC (Keyed-Hashing Method Authentication).
(c) Cryptographic key. Optionally, a cryptographic key or keys may also be provided in the page table entry for the swapped page. The key may be based upon, for example, AES (Advanced Encryption Standard, Federal Information Processing Standards Publication 197 (FIPS-197), Nov. 26, 2001) or any other cryptographic algorithm. The key or keys may be used by the disk controller for encrypting the page when the page is swapped out, and for decrypting the page when the page is being swapped back in. This element provides confidentiality, in addition to integrity, for information swapped out to disk on a protected program by program basis.
   In an embodiment of the invention, data writes and reads to a sector of a hard drive then include the following:

Data writes: The sequence number of the SIF is incremented on every write to the sector. In addition, the integrity check value of the SIF associated with the sector is updated on each write.

Data reads: The integrity check value of the SIF either is recalculated, or is provided to the VMM on a sector read. If the disk controller calculates the sector ICV, it can also compare it with the ICV on the disk and report the status (integrity “pass” or “fail”) to the VMM.

In an embodiment of the invention, the SIF is inaccessible on the hard disk except to the hard disk firmware. For example, similar functionality may be used as is used for conventional error correction codes. In an embodiment, the sequence number of each SIF is also incremented by the disk controller on every reboot of the system to ensure the liveness of the data on disk and to add a safeguard against replay attacks (in which older data is recorded and replayed in an attempt to bypass security).

In an alternative embodiment, the SIF may be also maintained in volatile memory (the amount of memory that is required for SIF storage being ICV_SIZE*NUM_BLOCKS). In such embodiment, the sequence numbers are not required. In other embodiments, a SIF may also be applied to any other device that persistently stores contents of memory that are fetched via direct memory access (DMA).

In an embodiment of the invention, a control bit which may be referred to as an Integrity/Clear (I/C) bit is added to the page table structure (such as a VT-d page table structure). In an embodiment, the interpretation of this bit by hardware is performed during the DMA remap page walk as follows:

(I) If the I/C bit is set, it is a signal to the disk controller (or any other DMA device) to perform integrity operations on the memory contents to be read/written from memory as follows:

(a) If the DMA access is a read, the disk controller sets the SIF field for the sectors written on the disk. The disk controller uses the sequence number field of the SIF as an additional input to the cryptographic hash generated for the SIF.

(b) If the DMA access is a write, the disk controller verifies the SIF fields for the sectors read from disk and, if the integrity check fails, sets a fault reason code appropriately. In an alternative embodiment, the disk controller may provide the ICV of the SIF to the management software (for example, the VMM) so that the management software may check the integrity value.

(II) If the Integrity/Check bit is reset, this is a signal to the disk controller to protect against a page from being swapped out of memory or swapped into memory (such as in cases in with confidential data is stored into protected memory and should not be swapped to disk):

(a) Clear the memory contents of the referenced memory upon a DMA read access (in circumstances in which a page is to be swapped out).

(b) Clear the memory contents of the referenced memory upon a DMA write access (in circumstances in which a page is to be swapped in)

In an embodiment of the invention, the setup of a system for swapped page data integrity protection may include the following:

(1) The integrity of an agent's code and static data (referred to collectively as data) is verified by a module, such as by an integrity measurement module residing in memory. In an embodiment, this verification includes loading the agent into memory either in its entirety or, as an alternative, loading the agent into memory on a page-by-page basis, using per-page integrity check values from the integrity manifest.

(2) If the integrity check succeeds for the agent, then the agent's memory pages containing data have been identified and checked. To protect the data integrity, the references to the agent's pages may be copied into a VMM managed protected page table structure, and the references in the active page table structure viewed by the OS are marked as not-present.

(3) From the hard disk (or other device) perspective, a DMA remapping page table structure is used to map DMA virtual addresses (DVA's) to host physical addresses (HPA's). For protected agent pages that are swapped out to disk, the DVA's are the same as the GPA's. In essence, pages that the guest OS believes are resident in GPA's are mapped to HPA's using the DMA remapping page tables. This may be utilized such that the content can be swapped to or from the disk, thereby freeing or filling the respective host physical pages.

(4) The hard disk controller device is assigned to a Guest OS using the DMA remap page tables. This implies that the disk controller is programmed using GPA's and is allowed to DMA in and out of the guest OS memory. Due to the agent integrity check process performed in setup the GPA and HPA for the pages occupied by the protected agent are known.

(5) The remap table is protected by:
(a) In a first embodiment, the DMA remap page table entry (PTE) mapping GPA's to HPA's for page swapping is marked as not-readable and not-writable. Since swap-in requires DMA write access and swap-out requires DMA read access for this mapping, the swap-in/out of these pages will result in a blocking fault (which may be reported by VT-d hardware).
(b) In a second embodiment, the DMA remap page table entry mapping GPA's to HPA's for page swapping is marked with the described I/C bit as appropriate for integrity check/set as well as page data protect (clear bit).

In an embodiment of the invention, a run-time implementation of swapped page integrity may include the following:

(1) After the setup has been completed as described above, the guest OS uses a set of protected page table structures when a protected agent is running.

(2) If one of the agent pages is marked by the OS to be swapped out to disk, the DMA read on that memory page will cause a walk of the DMA remap page table, which will map the GPA (or DVA, in this case) to the HPA from where the page frame must be moved to a disk sector. Assuming, for example, a 4K page was being moved to disk in this case (although size of the page is not a restriction for an embodiment of the invention), a set of one or more sectors will be used to persistently cache the contents for this page.

(3) In a first embodiment, if the I/C bit is set on certain pages, integrity for the pages will be set when being swapped into disk and integrity will be checked when the pages are being swapped out. Any errors detected during integrity check for swap-in will be reported by the disk controller. In a particular embodiment, the errors may be reported in fault registers exposed to the VMM by VT-d hardware. In addition, VT-d fault events may be reported to software using a message signaled interrupt and may be controlled through a fault event control register. The fault event information may be programmed through fault event data and fault event address registers. In an embodiment of the invention, an extension to the fault reporting mechanism may be made by way of new error codes, including:
Fault reason code 0xD: Integrity of swapping in page does not match SIF on disk sectors.
   In an alternative embodiment, any page that is marked for integrity check can be reported to the VMM on DMA in and DMA out. The hardware (disk controller) can provide the SIF and VMM can perform the integrity check on a swap-in event. If the integrity check fails (reported by the code above in the Fault registers) the VMM can take appropriate action by policy.

(4) In a second embodiment, there are two possible cases:
(a) When the R (read) bit on a PTE in the IO remap page table is off, and the attempted access is a DMA Read, this indicates a swap-out case. When a page is swapped out from memory, the page walk will hit a DMA page table mapping for which the permissions are set to disallow read. This would, for example, cause a VT-d fault that will be recorded in the Fault Recording registers along with information about the source of the DMA and the faulting address. Software is generally expected to handle DMA faults through the Fault Recording registers in a FIFO fashion starting from the Fault recording register until it finds a fault recording register with no more faults. In an embodiment, the VMM acts as the software in this case, which intervenes and captures a cryptographic hash of the page in memory. The VMM then sets the disk controller device registers to cause the DMA read operation to occur as expected by the guest OS. To complete this operation, the VMM extracts the disk sector from the guest OS copy of the page tables.
(b) When W (write) bit on a PTE in the IO remap page table is off, and the attempted access is a DMA Write, this indicates a swap-in case. When one of the pages is being reloaded by the guest OS, the page walk will hit a DMA page table mapping for which the permissions are set to disallow writes. A VT-d fault would be recorded as explained above and handled by the VMM. The VMM in this case will cause the write operation to occur by setting disk controller registers and then performing an integrity check of the page loaded in memory. In the period between the page being loaded and the integrity check completing, no access to the page is allowed because the control is in the VMM. If the integrity check passes, processing continues regularly else the VMM can take appropriate action by policy.

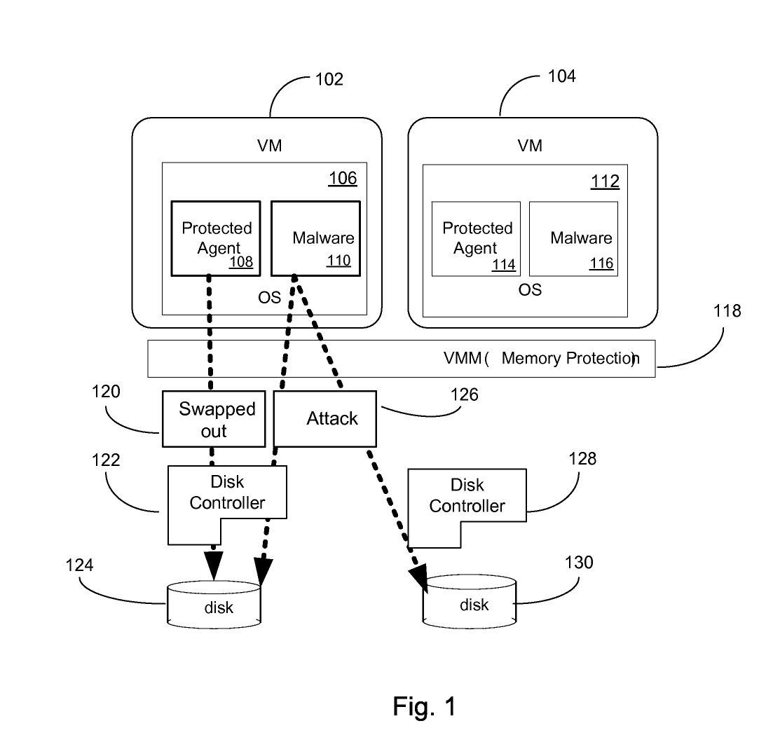

FIG. 1 is an illustration of memory that is vulnerable to attack the swapping of pages. In this illustration, multiple virtual machines (VM's) may be instantiated, including a first VM 102 and a second VM 104, as illustrated. The first VM 102 includes operating system 106, and the second VM 104 includes operating system 112. The operating systems include protected agents 108 and 114, but they can also include malware 110 and 116 that has entered the system. The system may include memory management software, such as VMM software 118, for the management of hardware resources for the multiple virtual machines.

The integrity of data of protected agent 108 may be verified by various means. The means may include, but are not limited to, the use of processes described in U.S. patent application Ser. No. 11/395,488 (“Intra-Partitioning of Software Components within an Execution Environment”), filed Mar. 30, 2006 and published as 2007/006,175, and U.S. patent application Ser. No. 11/323,446 (“Page Coloring to Associate Memory Pages with Programs”), filed Dec. 30, 2005. However, in the operation of the first VM 102, the pages of data of protected agent 108 may be swapped out 120 via a disk controller 122 to disk memory 124 or other persistent memory. Similarly in the operation of the second VM 104, data may be swapped out via a disk controller 122 to disk memory 124. The swapping out of data may allow access to an attack 126 by the malware 110 on data that is swapped out to disk 124. The attack 120 may also include compromising of data that is swapped from VM 104 to disk 130.

In an embodiment of the invention, the integrity of the data pages that are swapped out by the agent 108 is protected in the swap process. In an embodiment, the integrity of the pages may be established as it is swapped out, and then checked as the pages are swapped back in to memory.

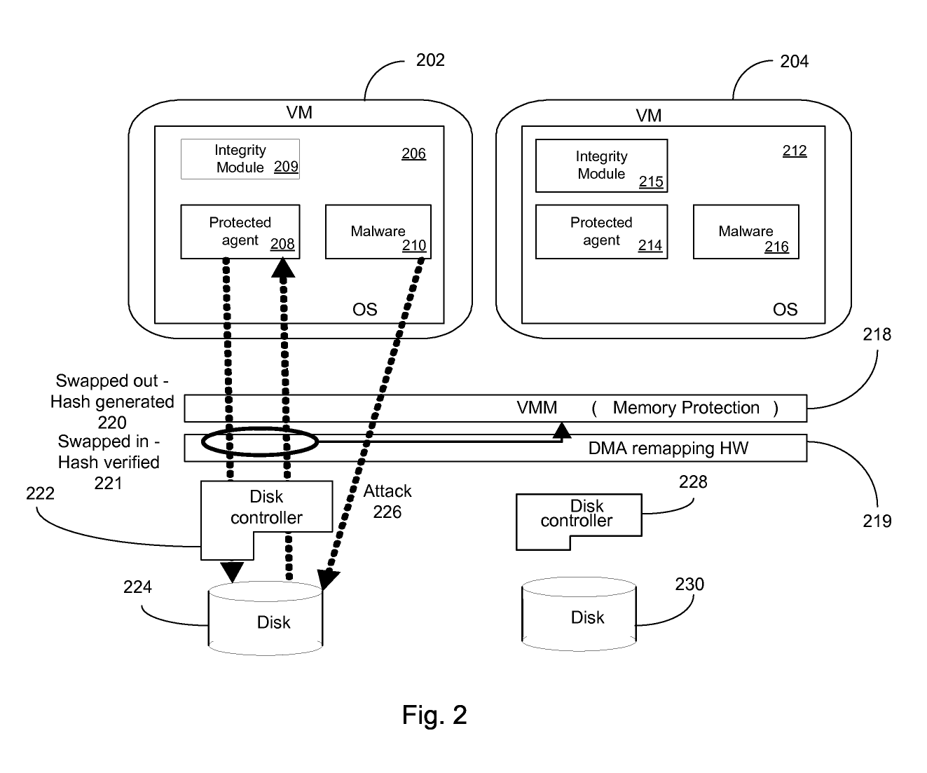

FIG. 2 is an illustration of a system to establish integrity of data swapped from primary to secondary memory. In this illustration, multiple virtual machines are present, including a first VM 202 and a second VM 204, as illustrated. The first VM 102 includes operating system 210, and the second VM 204 includes operating system 216. The operating systems include protected agents 108 and 114. Malware 208 and 214 that has entered the system, and may endanger the integrity of data. The system includes memory management software, such as VMM software 226, for the management of hardware resources for the multiple virtual machines. In an embodiment of the invention, the system may also include DMA remapping hardware 228 for use in mapping of addresses.

The integrity of data of protected agent 208 may be verified by a known means. In the operation of the first VM 202, the pages of data of protected agent 206 are swapped out via a disk controller 218 to disk memory 220 or other persistent memory. In the operation of the second VM 204, data may also be swapped out via a disk controller 230 to disk memory 232. In an embodiment of the invention, a hash is generated 224 when pages are swapped out to storage to provide integrity protection for the swapped pages. The hash value is verified 222 when the pages are swapped back into primary memory. If an attack 234 on the swapped out data is implemented on the swapped out data, the generated hash value 224 will not match when verified 222, and a fault condition will result.

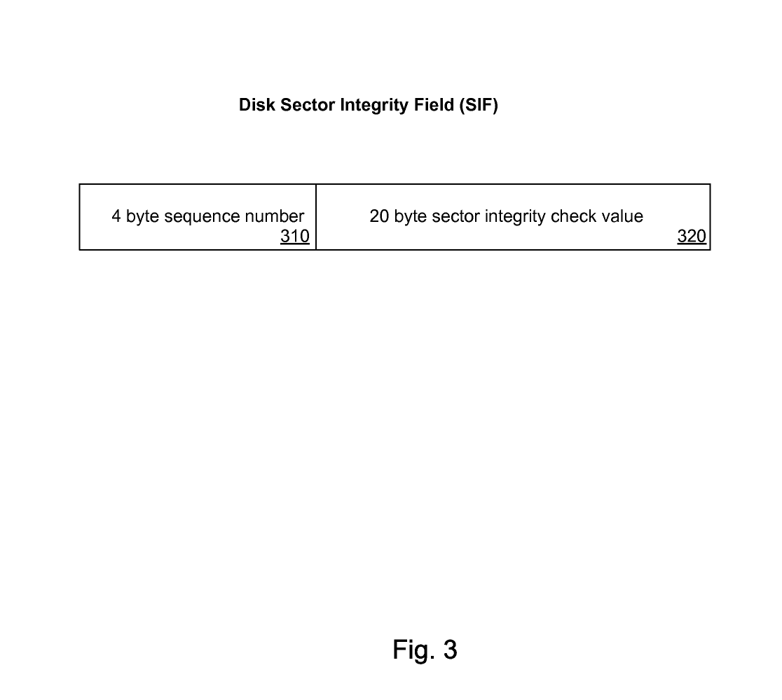

FIG. 3 is an illustration of an embodiment of a sector integrity field for a disk memory. The sector integrity field (SIF) may contain multiple fields, with the fields including a field to determine an integrity check hash value and a sequence number to count write occurrences. In a particular example, each sector of a hard drive may include a SIF that includes a first field containing a 4-byte sequence number and a second field that contains a 20-byte sector integrity check value. In an embodiment, the SIF values may be used to confirm the integrity of data that is swapped out of primary memory into secondary memory and swapped back into primary memory.

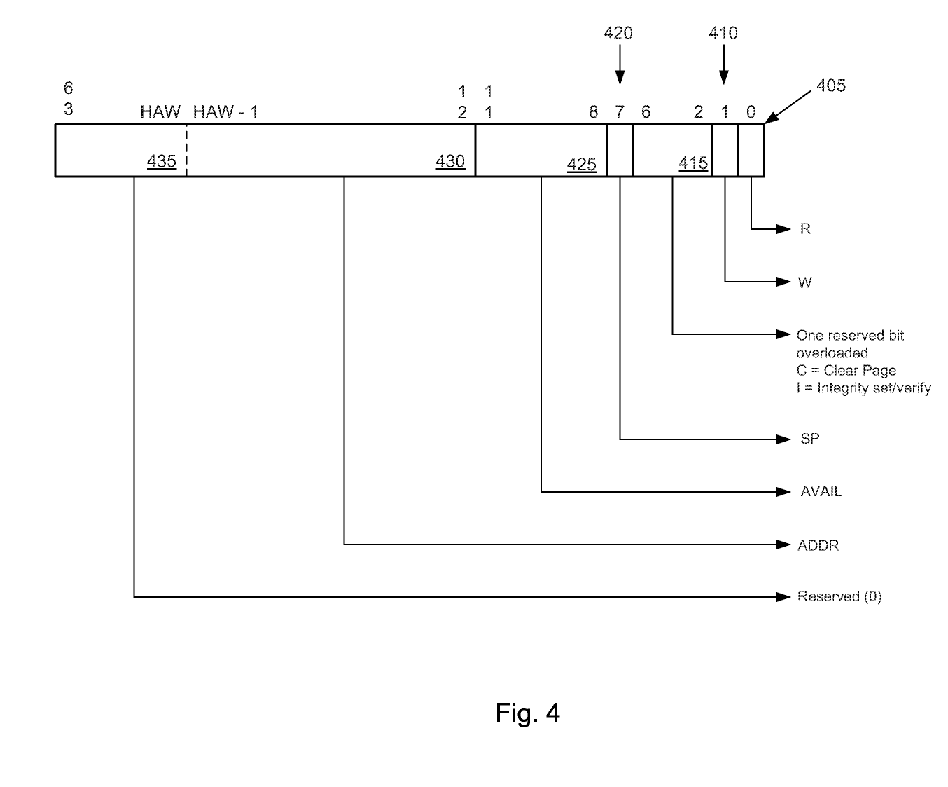

FIG. 4 is an illustration of an embodiment of a remap page table entry. In this illustration, a DMA remap page table entry is modified in order to support the protection of the integrity of data that is swapped in and out of memory. In an embodiment, the page table entry may include a reserved bit in a field 415, with the value either indicating clear page (C) or integrity set and verify (I). In an embodiment, the reserved bit may be used in the protection of integrity of data page swaps.

In an embodiment, the remap table may include certain other data fields. The entries may include, but are not limited to, fields provided for page table entries for the Intel Virtualization Technology for Directed I/O Architecture Specification (February 2006). The fields may including an address field (ADDR 430), including reserved area (Reserved (0) 435), for host physical address of the page frame (if a leaf node) or the next level page table; a field that is available for software use and that is ignored by hardware (AVAIL 425); a “super page” (SP 420) to tell hardware whether to stop a page-walk before reaching a leaf node mapping to a page; a writable bit (W 410) to indicate whether the page is writable for DMA; and a readable bit (R 405) to indicate with the page is readable for DMA.

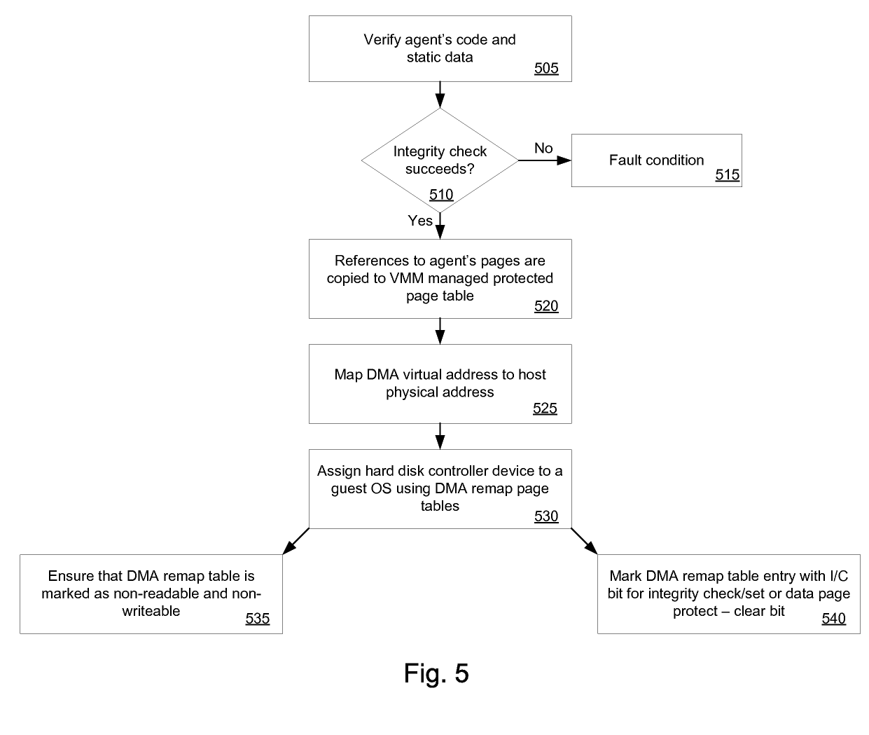

FIG. 5 is an illustration of an embodiment of a process for the set up of a system to provide swapped page data integrity protection. In an embodiment, the integrity of an agent's data is verified by a module, such as by an integrity measurement module residing in memory. In an embodiment, this verification includes loading the agent into memory either in its entirety or, as an alternative, loading the agent into memory a page by page basis, with a per page integrity check value support in the integrity manifest. If the integrity check 510 does not succeed, then there is a fault condition. If the integrity check succeeds for the agent, then the agent's memory pages containing data have been identified and checked. To protect the data integrity, the references to the agent's pages may be copied into a VMM managed protected page table structure.

In an embodiment of the invention, a DMA remapping page table structure is used to map DMA virtual addresses (DVA's) to host physical addresses (HPA's) 525. For protected agent pages that are swapped out to disk, the DVA's are the same as the GPA's. The relevant hard disk controller device is assigned to a Guest OS using the DMA remap page tables 530, which implies that the disk controller is programmed using GPA's and is allowed to DMA in and out of the guest OS memory.

In an embodiment of the invention, the remap table may be protected by marking the remap page table entries that remap GPA's to HPA's for page swapping as “not-readable” and “not-writable” 535. Swap-in requires DMA write access and swap-out requires DMA read access for this mapping, and thus the swap-in/out of these pages will result in a blocking fault. In a second embodiment, the DMA remap page table may be protected by the page table entry being marked with the described I/C bit as appropriate for integrity check/set or page data protect (clear bit) 540.

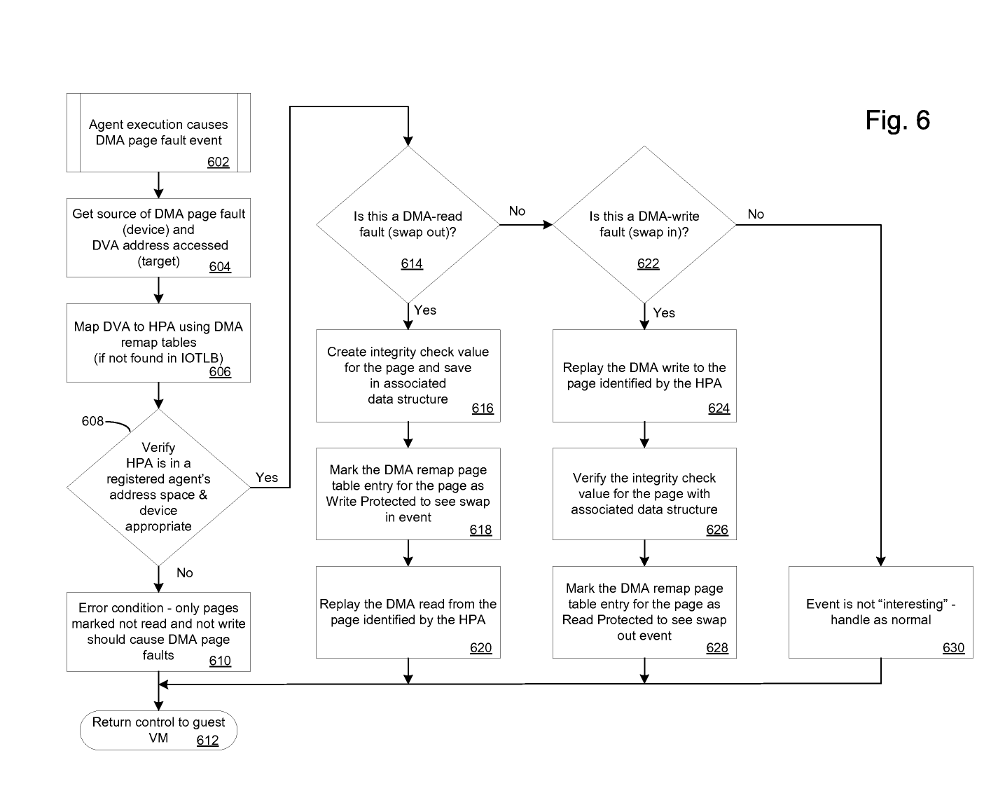

FIG. 6 is an illustration of an embodiment of a run-time implementation of swapped page integrity. In this illustration, a process may be initiated by agent execution causing a DMA page fault event 602. The source of the DMA page fault (which is the relevant device) and the DVA address that is accessed (which is the data target) are obtained 604. The DVA is mapped to HPA using the relevant DMA mapping tables, assuming that it is not found in the IOTLB (I/O Translation Look-aside Buffer) 608. A verification is made that the HPA is in registered agent's address space and that the device is appropriate 608. If not, then there is an error condition 610, and control is returned to the guest VM 612.

If the verification is successful, then there is a determination whether the event is a DMA read fault, indicating a swap-out event 614. If there is a swap-out, then an integrity check value for the page is created and is saved in the associated data structure 616. The DMA remap page is then marked as write protected in order to see the subsequent swap-in event 618, and there is replay of the DMA read from the page identified by the HPA to perform the swap-out 620. Control is then returned to the guest VM 612.

If there is not a DMA-read fault indicating a swap-out 614, then there is determination whether there is a DMA-write fault, thereby indicating a swap-in event 622. If so, there is replay of the DMA write to the page identified by the HPA 624, and there is verification of the integrity check value of the page with the associated data structure 626. The DMA remap page table is then marked as read protected in order to see a subsequent read out event 628. Control is then returned to the guest VM 612.

If the determination of DMA-write fault fails 622, then the event is neither a swap-out of data or swap-in of data, and thus the event is “not interesting” for the purposes of swap data integrity, and is handled as normal 630, with control then returning to the guest VM 612.

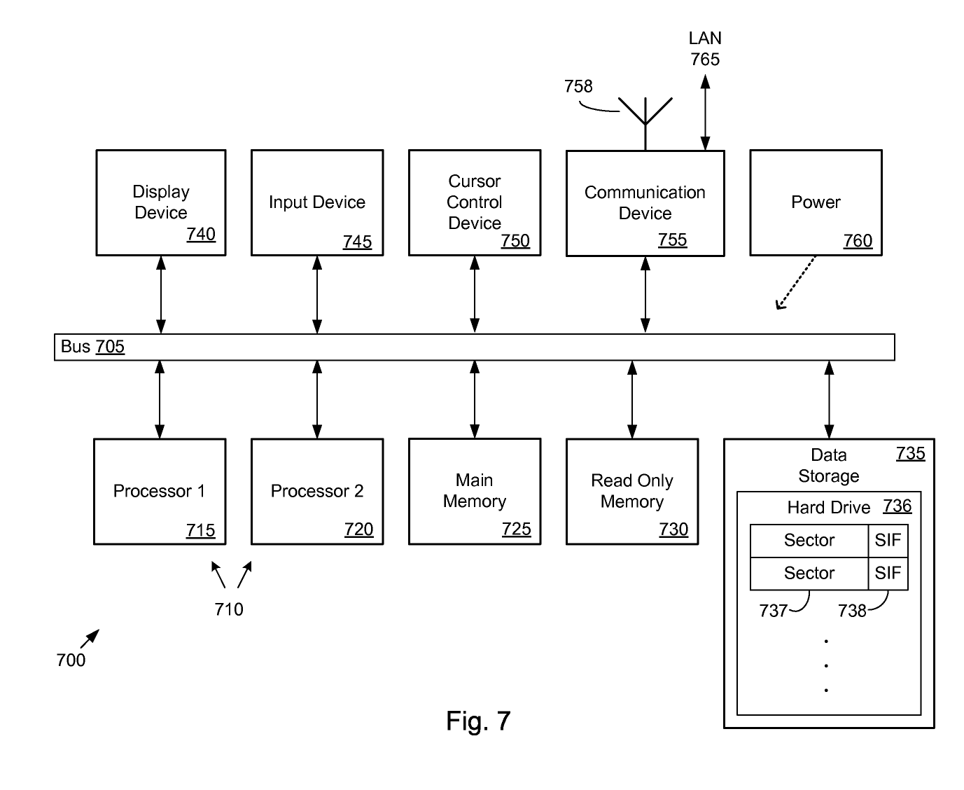

FIG. 7 is an illustration of a computer system that may be utilized an embodiment of the invention. Certain standard and well-known components that are not germane to the present invention are not shown. Under an embodiment of the invention, a computer 700 comprises a bus 705 or other communication means for communicating information, and a processing means such as two or more processors 710 (shown as a first processor 715 and a second processor 720) coupled with the bus 705 for processing information. The processors 710 may comprise one or more physical processors and one or more logical processors. Further, each of the processors 710 may include multiple processor cores. The computer 700 is illustrated with a single bus 705 for simplicity, but the computer may have multiple different buses and the component connections to such buses may vary. The bus 705 shown in FIG. 7 is an abstraction that represents any one or more separate physical buses, point-to-point connections, or both connected by appropriate bridges, adapters, or controllers. The bus 705, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”. (“Standard for a High Performance Serial Bus” 1394-1995, IEEE, published Aug. 30, 1996, and supplements)

In an embodiment of the invention, the processors 710 may be utilized to support one or more virtual machines. In an embodiment of the invention, the computer 700 further comprises a random access memory (RAM) or other dynamic storage device as a main memory 725 for storing information and instructions to be executed by the processors 710. Main memory 725 also may be used for storing temporary variables or other intermediate information during execution of instructions by the processors 710. The main memory 725 may include pages for a protected agent, which may be swapped out to secondary and swapped back to the main memory. RAM memory includes dynamic random access memory (DRAM), which requires refreshing of memory contents, and static random access memory (SRAM), which does not require refreshing contents, but at increased cost. DRAM memory may include synchronous dynamic random access memory (SDRAM), which includes a clock signal to control signals, and extended data-out dynamic random access memory (EDO DRAM). The uses of the main memory may include the storage received signals from wireless devices. The computer 700 also may comprise a read only memory (ROM) 730 and/or other static storage device for storing static information and instructions for the processors 710.

Data storage 735 may also be coupled to the bus 705 of the computer 700 for storing information and instructions. The data storage 735 may include a magnetic disk or optical disc and its corresponding drive, flash memory or other nonvolatile memory, or other memory device. Such elements may be combined together or may be separate components, and utilize parts of other elements of the computer 700. In a particular embodiment of the invention, the data storage 735 may include a hard drive 736, which may provide persistent memory for the swapping of data to and from the main memory 725. In one embodiment of the invention, each sector 737 of the hard drive 736 may include a sector integrity field (SIF) 738 for use in protecting the integrity of data that is swapped into the hard drive 736

The computer 700 may also be coupled via the bus 705 to a display device 740, such as a cathode ray tube (CRT) display, a liquid crystal display (LCD), a plasma display, or any other display technology, for displaying information to an end user. In some environments, the display device may be a touch-screen that is also utilized as at least a part of an input device. In some environments, display device 740 may be or may include an audio device, such as a speaker for providing audio information. An input device 745 may be coupled to the bus 705 for communicating information and/or command selections to the processors 710. In various implementations, input device 745 may be a keyboard, a keypad, a touch-screen and stylus, a voice-activated system, or other input device, or combinations of such devices. Another type of user input device that may be included is a cursor control device 750, such as a mouse, a trackball, or cursor direction keys for communicating direction information and command selections to the one or more processors 710 and for controlling cursor movement on the display device 740.

A communication device 755 may also be coupled to the bus 705. Depending upon the particular implementation, the communication device 755 may include a transceiver, a wireless modem, a network interface card, LAN (Local Area Network) on motherboard, or other interface device. The uses of a communication device 755 may include reception of signals from wireless devices. For radio communications, the communication device 755 may include one or more antennas 758. In one embodiment, the communication device 755 may include a firewall to protect the computer 700 from improper access. The computer 700 may be linked to a network, such as LAN (local area network) 765, or to other devices using the communication device 755, which may include links to the Internet, a local area network, or another environment. The computer 700 may also comprise a power device or system 760, which may comprise a power supply, a battery, a solar cell, a fuel cell, or other system or device for providing or generating power. The power provided by the power device or system 760 may be distributed as required to elements of the computer 700.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes can be added to or deleted from any of the methods and information can be added or subtracted from any of the described messages without departing from the basic scope of the present invention. It will be apparent to those skilled in the art that further modifications and adaptations can be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
verifying integrity of a memory page stored in primary computer memory;
swapping the memory page out of the primary computer memory to a secondary memory, swapping the memory page out including recording an integrity check value of the memory page; and
swapping the memory page into the primary computer memory from the secondary memory, swapping the memory page in including verifying the integrity of the memory page based at least in part on the integrity check value recorded during swapping out the memory page.

2. The method of claim 1, wherein the secondary memory comprises a hard drive, the memory page being stored in a sector of the hard drive.

3. The method of claim 2, wherein performing an integrity check of the memory page includes storing an integrity value in a field of the sector of the hard drive.

4. The method of claim 3, further comprising incrementing a value in a second field of the second of the hard drive upon swapping the memory page in the sector.

5. The method of claim 1, where recording the integrity check value includes the storage of the integrity check value by a disk controller.

6. The method of claim 5, wherein verifying the integrity of the memory page includes the disk controller reporting an error in integrity verification to system software.

7. The method of claim 1, further comprising detecting the swap-out event based on a memory access read fault for the primary memory, and detecting the swap-in event based on a memory access write fault for the primary memory.

8. The method of claim 1, further comprising copying a reference to the memory page to a protected page table.

9. The method of claim 8, further comprising remapping the virtual address of the memory page to a physical address.

10. The method of claim 8, further comprising marking a field of the page table entry to provide integrity verification and checking.

11. The method of claim 8, wherein a page table entry for the memory page specifies a cryptographic key to be used to encrypt or decrypt the memory page.

12. The method of claim 8, further comprising marking a field of a second page table entry for a second memory page to clear the second memory page upon an attempt to read or write the contents of the memory page.

13. A security apparatus for swapped memory data comprising:
a virtual machine, the virtual machine including a protected agent, the protected agent having a memory page; and
a virtual machine monitor, the virtual machine monitor to:
check the integrity of the memory page upon the memory page being swapped out from primary memory to secondary memory, and
verify the integrity of the memory page upon the memory page being swapped in from secondary memory to primary memory.

14. The apparatus of claim 13, further comprising a module to verify integrity of the memory page in primary memory.

15. The apparatus of claim 13, further comprising a page table, the page table to include a reference to the memory page.

16. The apparatus of claim 15, the page table being protected from unauthorized access.

17. The apparatus of claim 15, wherein the page table is map the virtual address of the memory page to a physical address.

18. The apparatus of claim 15, wherein the page table includes a field to direct integrity verification for memory pages.

19. The apparatus of claim 18, wherein the page table includes a field to direct the clearing of a memory page upon an attempt to read or write the data of the memory page.

20. The apparatus of claim 18, wherein the page table includes a field for a cryptographic key for encryption of the memory page on swapping out the memory page or decryption of the memory page on swapping in the memory page.

21. A computer system comprising:
a dynamic random access memory, the memory to contain data for a virtual machine, the virtual machine including a protected agent, the protected agent having a page of data;
a hard drive device, the protected agent to swap the page of data from the memory to the hard drive device and to swap in the page of data from the hard drive devise to the memory; and
a virtual memory monitor to manage system hardware for the virtual machine, the virtual memory monitor to generate an integrity check value for the page of data during the swapping out of the page of data and to verify the integrity check value during the swapping in of the page of memory.

22. The computer system of claim 21, wherein the page of data is swapped into a sector of the hard drive device, the sector including a sector integrity field.

23. The computer system of claim 22, wherein the sector integrity field includes a first field to contain an integrity check hash value for contents of the sector.

24. The computer system of claim 23, wherein the sector integrity field includes a second field to contain a sequence number to count write events for the sector.

25. The computer system of claim 21, further comprising a disk controller, the disk controller to store the integrity check value, and to report to the virtual memory monitor upon detection of an error in verification of the integrity check value.

26. An article of manufacture comprising:
a machine-accessible medium including data that, when accessed by a machine, cause the machine to perform operations comprising:
verifying integrity of a memory page stored in a physical memory;
swapping the memory page out of the physical memory to a persistent memory, swapping the memory page out including performing an integrity check of the memory page; and
swapping the memory page into the physical memory from the persistent memory, swapping the memory page in including verifying the integrity of the memory page based at least in part on the integrity check performed for swapping out the memory page.

27. The article of manufacture of claim 26, wherein performing an integrity check of the swapped out memory page includes storing an integrity value in a first field of the persistent memory.

28. The article of manufacture of claim 27, wherein the machine-accessible medium further includes data that causes the machine to perform operations comprising:
incrementing a value in a second field of the persistent memory upon swapping the memory page out to persistent memory.

29. The article of manufacture of claim 26, wherein the machine-accessible medium further includes data that causes the machine to perform operations comprising:
detecting a memory swap event based on a direct memory access fault.

30. The article of manufacture of claim 26, wherein the machine-accessible medium further includes data that causes the machine to perform operations comprising:
copying a reference for the memory page to a protected page table.
